(19) United States
(12) Patent Application Publication
(10) Pub. No.: US 2025/0187830 A1
(43) Pub. Date: Jun. 12, 2025

(54) RACK OPERATING DEVICE, RACKING SYSTEM AND METHOD FOR ASSEMBLING A RACKING SYSTEM

(71) Applicant: Gebhardt Foerdertechnik GmbH, Sinsheim (DE)

(72) Inventors: Marco Gebhardt, Sinsheim (DE); Jürgen Nosch, Feldkirch (AT); Michael Auer, Bad Rappenau (DE)

(21) Appl. No.: 18/970,534

(22) Filed: Dec. 5, 2024

(30) Foreign Application Priority Data
Dec. 6, 2023 (DE) 10 2023 212 314.2

(51) Int. Cl. B65G 1/06

(52) U.S. Cl. CPC B65G 1/06

(57) ABSTRACT

With a view to an inexpensive access to parts of a racking system using structurally simple means, a rack operating device for the racking system, in particular for a storage and retrieval system, is specified. The rack operating device has two masts extending in the vertical direction and a lifting unit movably arranged on the mast. The rack operating device is designed and developed such that the lifting unit carries two load-handling devices which can be moved in the horizontal direction in the lifting unit.

A specified racking system is designed accordingly. A method for assembling the racking system is specified.

### BACKGROUND

### Technical Field

The disclosure relates to a rack operating device for a racking system, in particular for a storage and retrieval system, wherein the rack operating device has two masts extending in the vertical direction and a lifting unit movably arranged on the masts.

The disclosure further relates to a racking system, in particular a storage and retrieval system, with a rack storage unit with at least two opposing storage racks, wherein the at least two opposing storage racks each have one or more compartments for a stored item in one rack level or in a plurality of rack levels lying one above the other, and with at least one rack operating device.

The disclosure further relates to a method for assembling a racking system.

### Description of the Related Art

Rack operating devices or also lifts of the type in question have been known in practice for years and serve for accessing the goods in a racking system, in particular in a storage and retrieval system similar to a high-bay warehouse.

Known rack operating devices are located in front of the respective storage rack or in a rack aisle formed between two storage racks. In this context, the arrangement of the rack operating devices is crucial to achieving the necessary throughput of goods in the racking system. The rack operating devices are arranged in front of/next to/between the storage racks and at a distance from the storage racks.

Such rack operating devices have at least one mast extending in a vertical direction and a lifting unit movably arranged on the mast for transporting stored items. The rack operating device can thus transport stored goods in a vertical direction using the lifting unit and can place them into, or remove them from, racking systems. All types of pallets, containers, trays, and boxes can be used as load carriers for the stored or conveyed goods. This also includes all load carriers that are used, for example, in supermarkets—for example, a package with six bottles of barbecue sauce that has only a cardboard “tray” on the bottom and is film-wrapped/shrink-wrapped. Envelopes and/or polybags—for example, containing textile goods—can also be considered stored goods.

However, known rack operating devices are not optimal in terms of costs and space consumption.

### BRIEF SUMMARY AND GENERAL DESCRIPTION

The present disclosure is therefore based on an object of designing and developing a rack operating device as well as a corresponding racking system in such a way that with structurally simple means more economical access to the parts of the racking system is ensured. A space-saving, inexpensive and access-optimized alternative is to be created. Furthermore, an efficient and simplified method for assembling the racking system is to be specified, which ensures fast, inexpensive and easy assembly of the rack operating device.

According to an embodiment of the disclosure, the rack operating device is characterized in that the lifting unit carries two load-handling devices which can be moved in the horizontal direction in the lifting unit.

In accordance with the disclosure, it has been recognized firstly that the underlying object can be achieved by a clever design of the lifting unit. Specifically, the lifting unit carries two load-handling devices. The load-handling devices can be moved horizontally by the lifting unit. This means that two opposing storage racks can be served with the rack operating device. However, only a single rack operating device with a single lifting axis is required. The lifting unit can be moved on the mast(s). This means that two load-handling devices can be moved in a vertical direction along the lifting axis by means of the lifting unit. Masts and lifting units account for a significant proportion of the costs of the rack operating device.

Because two load-handling devices each share one lifting unit and thus one lifting axis and possibly only one drive device, the overall number of masts, lifting units, lifting cages and drive devices is reduced.

A rack operating device is thereby proposed that with simple structural means ensures more economical access to the parts of the racking system. The rack operating device offers a space-saving, inexpensive and access-optimized alternative.

With regard to a particularly simple design and advantageous kinematics of the rack operating device, each lifting unit is arranged on two masts so that it can move in the vertical direction. This allows lighter masts to be used. The lifting unit can be designed more simply.

According to one embodiment, each lifting unit can be assigned two separate masts which are preferably located laterally in an x-direction to the left and right of the lifting unit, in other words to the left and right from the perspective of an observer standing in front of the storage rack. A right-hand mast of a first lifting unit located on the left can be arranged directly in a horizontal x-direction next to a left-hand mast of a second lifting unit located on the right. Each lifting unit therefore has its own two mast profiles so that each rack operating device is modular and individually adjustable. In addition, the masts can be easily attached to the storage rack with bracing elements in the horizontal z-direction. However, a larger number of masts is required and the space requirement is increased.

One way to reduce the space requirement is for the right-hand mast of the first lifting unit on the left to be arranged offset in the horizontal z-direction in relation to the left-hand mast of the second lifting unit on the right. In other words, the two masts of the same rack operating device are arranged offset from each other in the horizontal z-direction, while both masts are arranged essentially the same in the x-direction. The offset arrangement reduces the space required in the x-direction when several rack operating devices are arranged next to each other. Depending on the achievable size of the components, at least a small aisle/free space could be created in the middle or in the aisle, which is not possible with known racking systems.

Preferably, two lifting units arranged next to each other to the left and right share the mast arranged between them. The mast is thus used by lifting units/lifting cages on both sides. This reduces the overall number of masts and the space required. Assembly time can also be saved.

According to one embodiment of the rack operating device, a drive device can move the lifting unit on the mast via at least one suspension means extending in the vertical y-direction, preferably in the vertical upward and/or downward direction. The suspension means can, for example, be designed as a belt.

The drive device can, for example, be arranged centrally below the lifting unit. In this case, the space required for the drive or a motor of the drive device in the z-direction—i.e., in the horizontal direction into the storage rack or out of the storage rack and into the rack aisle—is minimized. The drive is easily accessible with regard to maintenance and adjustments. For safety reasons, it is possible to unplug a shaft of the motor from an adjacent rack operating device and/or disconnect it from the power supply. Moreover, safety of operation can be increased by having two suspension means—one to the left and one to the right of the drive. However, this variant results in a relatively large lower approach dimension. The lower approach dimension is the lowest position in the vertical y-direction that the lifting unit of the rack operating device can reach due to its design. Since the drive device takes up the space at the foot of the mast, the lifting unit cannot be lowered all the way to the ground. A disadvantage of a rather large lower approach dimension is that the storage capacity decreases because there is overall less space available for rack levels—for example, in the warehouse.

As a variant, the drive device can be arranged in front of or behind the lifting unit/lifting axis in the z-direction. This makes the drive device and all its components particularly easy to access, and the lower approach dimension is reduced considerably. For safety reasons, the shaft can be disconnected from the front. Moreover, safety of operation can be increased by having two suspension means—one to the left and one to the right of the drive. However, the space required in the z-direction for the drive device and the motor increases. The components are “in the way” or in the rack aisle.

According to a particularly advantageous development, the drive device can be designed as a drive console for particularly good accessibility, which can be pulled like a drawer into the rack aisle or in the direction of an access area. A particularly rigid construction is advantageous.

As a further variant, the drive device can be located laterally next to the lifting unit in the x-direction. This variant offers advantageous accessibility to the drive unit and advantageous space requirements. The drive unit has only one belt thickness/width in the x-direction, while the previously described variants require twice the belt width. In terms of safety of operation, one lateral drive device can also drive only a single lateral suspension means. The motor size is limited.

According to a further embodiment, two drive devices can also be provided per lifting unit, which are located in the x-direction on both sides next to the lifting unit—in other words, to the left and right of the lifting unit. This design is advantageous in terms of safety, because the lifting unit can be equipped with two suspension means and/or brakes. The brakes can also be assigned directly or indirectly to the drive device. However, a larger approach dimension results if motors are partially arranged below the lifting unit. In addition, an electronic synchronization of the two drive devices must be ensured.

As a further variant, the drive device can also be arranged at the top of the mast head.

With regard to a stable construction, the lifting unit can be fixed to the mast with one degree of freedom in the vertical direction. The pivot point of the lifting unit on the mast is defined by the torque caused by the lifting unit and/or stored item around the x- and/or z-axes. Depending on the design of the rack operating device, this makes possible a lightweight construction of the mechanics and smaller drives in the drive devices.

With regard to the usability of smaller motors or drive devices, a counterweight designed for the lifting unit can also be provided and, if necessary, brought into engagement with the suspension means, for example if the drive device(s) is/are located to the side of the lifting unit.

The lifting unit can have a lifting cage with guide elements for connection to the mast. The guide elements can define the degree of freedom in the vertical direction and can be designed as rollers, for example. According to another embodiment, the guide elements can be designed as linear rails. The lifting cage can have aluminum profiles for inexpensive production and weight reduction. Alternatively or additionally, the lifting cage could be designed so as to include thin sheets, preferably metal sheets, or composite materials.

The lifting unit further carries at least two load-handling devices which can be moved horizontally in the lifting unit. Specifically, the load-handling devices can be movable in the lifting cage. The load-handling devices can be designed as a module including push-out drive and guide rails. Optionally, the push-out drive can be designed to be pluggable at the rear—i.e., in the z-direction away from the storage rack to be served—so that the push-out drive can be quickly replaced without removing the load-handling device.

The load-handling device can be mounted in a floating manner and can be centered with an extension movement if necessary.

Each load-handling device can have tines that enable the load-handling device to grip many different conveyed and/or stored items from below. This can be advantageous in particular for goods with very heterogeneous packaging—for example, supermarket goods.

In order to advantageously centralize the electrical components, the load-handling device can include sensors for the horizontal axis and/or vertical axis. If, as described above, two lifting units arranged next to each other to the left and right share the mast arranged between them, the two lifting units or both rack operating devices can only be adjusted together. The load-handling device can preferably be individually adjustable relative to the lifting cage via adjusting screws—i.e., independently of the lifts/masts. In other words, wherever possible, the load-handling device is adjusted instead of the masts.

According to a particular embodiment, the rack operating device can have two drive devices for two lifting units, each with a load-handling device. This significantly increases the throughput in the racking system. The two drive devices can be arranged, for example, by combining two different drive positions—in the z-direction “behind,” “under” and/or “in front of” the lifting unit with the respective load-handling device. There can be two belts on the sides of the lifting cages for each drive.

The rack operating device has two load-handling devices in the same lifting unit or in the same lifting cage. The load-handling devices can be arranged one above the other in the same lifting cage. A single drive device can be sufficient. However, due to the greater weight of the lifting unit with the two load-handling devices, this drive device is larger. This can have an impact on the rack grid in the x-direction and/or on the lower approach dimension of the lifting unit.

A height grid of the load-handling devices can preferably correspond to a height grid of the storage rack so that simultaneous operation, i.e., loading/unloading of conveyed/stored items, is possible in two vertically adjacent rack levels. This measure also increases throughput in the racking system.

It is also possible to telescope the two load-handling devices individually and independently of each other, which can also increase throughput. For example, this could be achieved by providing separate horizontal axes.

According to a particularly advantageous embodiment, the two load-handling devices are aligned in opposite orientations in the horizontal z-direction. In this way, the two opposing storage racks can be served with a single rack operating device which is arranged in a rack aisle between two opposing storage racks.

With regard to an improved racking system, a racking system, in particular a storage and retrieval system, with a rack storage unit with at least two opposing storage racks is proposed. The at least two opposing storage racks each have one or more compartments for conveyed/stored items in one rack level or in a plurality of rack levels arranged one above the other. The racking system has at least one rack operating device according to the disclosure.

One rack aisle can in each case be formed between the storage racks. In each case a mast arranged in the rack aisle can be connected to the two storage racks by means of at least one bracing element. In other words, the bracing extends in the z-direction.

According to an optimized arrangement, at least three or more rack operating devices are provided per storage rack not only in order to optimally use the racking network but also to be able to optimally install the rack operating devices.

With regard to increased dimensional accuracy and the ability to maintain smaller tolerances as well as increased dimensional stability, at least two masts in the racking system can be connected by at least one cross strut extending in the horizontal direction. In other words, the cross strut extends in the x-direction.

The two masts do not necessarily have to be two masts that are assigned to the same lifting unit as described above. The cross strut or cross struts can also connect and brace more than two masts. The masts in the x-direction can preferably—but not necessarily—have the same division as the compartments of the storage rack and/or—if the masts do not replace the rack uprights—have the same division as the rack uprights.

In addition, the masts can be doweled to the ground and set in cement to improve bracing and to avoid a “parallelogram effect.”

The cross struts can connect the masts to the masts of the other—preferably neighboring—cells or storage racks. Alternatively or additionally, the bracing can also be improved by structures, other shelving elements, platforms and/or other auxiliary structures. In this way the storage rack and rack operating device can be braced.

By reducing the number of lifting axes, the rack aisle is comparatively free, and the rack operating devices are easily accessible. Furthermore, the use of advanced camera and/or sensor systems is made possible. Cameras need a large field of view to replace the sensor systems that are currently used. A camera must be able to be positioned so that it can see all relevant regions. With a corresponding field of view, a camera can detect conveyed goods/stored items and/or clearances and/or errors.

According to a preferred development, the mast heads of two masts arranged next to each other can be connected to each other by a cross strut. Such a cross strut can also be called a crossbeam. The crossbeam also serves for bracing. The crossbeam can preferably be made of angled sheet metal.

The upper mast section can be adjusted overall in the y-direction to the rack height. The rack height often depends on the building.

In the variant described above in which the drive device is arranged at the top of the mast head, the crossbeam can also be a cover for the drive device.

A method for assembling the racking system as described herein comprises the following steps:
a) mounting the at least one mast when setting up the rack storage unit with at least one storage rack,
b) checking dimensional accuracy and/or maintenance of tolerances,
c) mounting the lifting unit(s) of the racking system and preferably the drive device(s) and/or load-handling devices, and
d) wiring and preferably installing the sensor system.

In known methods for assembling racking systems, lifts or rack operating devices including the masts, for example ten meters high, are delivered in one piece. This results in a large amount of space being required, not only during assembly but also for intermediate storage. For safety reasons, it is not possible to remain in the immediate vicinity while the lift is being erected since the lift could fall.

Preferably, therefore, according to the method according to the disclosure, the lifting cage can be installed and adjusted by hand—without aids—or with hand tools/light equipment on the mast or between the masts after the masts have been provided during rack assembly. Preferably, the suspension means can be threaded in via ladders, which can be attached to the bracing, for example. In the context of wiring, an energy chain can be attached to the bracing elements—also by way of example—whereby here too access can be made possible via the ladders. One advantage here is that the energy chain is detached from the mast/lift so that no energy chain guide is required. The ladders could also be arranged at the front of the mast.

In the context of the construction of the rack storage unit in step a), the mast head with the crossbeam and/or the bracing can also be installed as described, as well as other components that are required for dimensionally accurate assembly.

In the context of the mechanical assembly of the lifting unit in step c), additional assemblies can be installed in addition to the lifting unit, if necessary with the load-handling device. This makes possible improved processes on construction sites since the lifts no longer have to be transported as a whole, and downstream sections of the plant can therefore start earlier with their activities. The parts to be moved are smaller and less critical in terms of occupational safety. It will also be possible to mount maintenance platforms or conveyors in front of the rack and only then add the remaining components.

This provides an efficient and simplified method for assembling the racking system, which ensures fast, inexpensive and easy installation of the rack operating device.

### BRIEF DESCRIPTION OF THE SEVERAL VIEWS OF THE DRAWINGS

There are various possibilities for designing and developing the teaching of the present disclosure in an advantageous manner. To this end, reference is made to the following explanation of preferred exemplary embodiments of the disclosure based upon the drawings. In connection with the explanation of the preferred exemplary embodiments of the disclosure based upon the drawing, generally preferred embodiments and developments of the teaching are also explained. In the drawings:

FIG. 1 shows a top view from above of a racking system with rack operating devices according to the prior art,

FIG. 2 shows a perspective view of the rack operating systems with two load-handling devices per lifting unit,

FIG. 3 shows a sectional view from above of a conventional rack upright and a mast,

FIG. 4 shows in a perspective view of the conventional rack upright and the mast from FIG. 3,

FIG. 5 shows a perspective view of crossbeams on the mast head,

FIG. 6 shows a plan view from above of an embodiment of the racking system according to the disclosure with masts arranged offset,

FIG. 7 shows a plan view from above of an embodiment of the racking system according to the disclosure, in which two lifting units arranged next to each other on the left and right share the mast arranged between them,

FIG. 8 shows a side view of a lifting unit of a rack operating device according to the prior art,

FIG. 9 shows a perspective view of two embodiments of lifting cages for lifting units of the rack operating device according to the disclosure,

FIG. 10 shows a perspective view of a load-handling device with a rear pluggable push-out drive,

FIG. 11 shows a perspective view of a load-handling device as a module, and

FIG. 12 shows a simplified block diagram of the method according to the disclosure.

### DETAILED DESCRIPTION

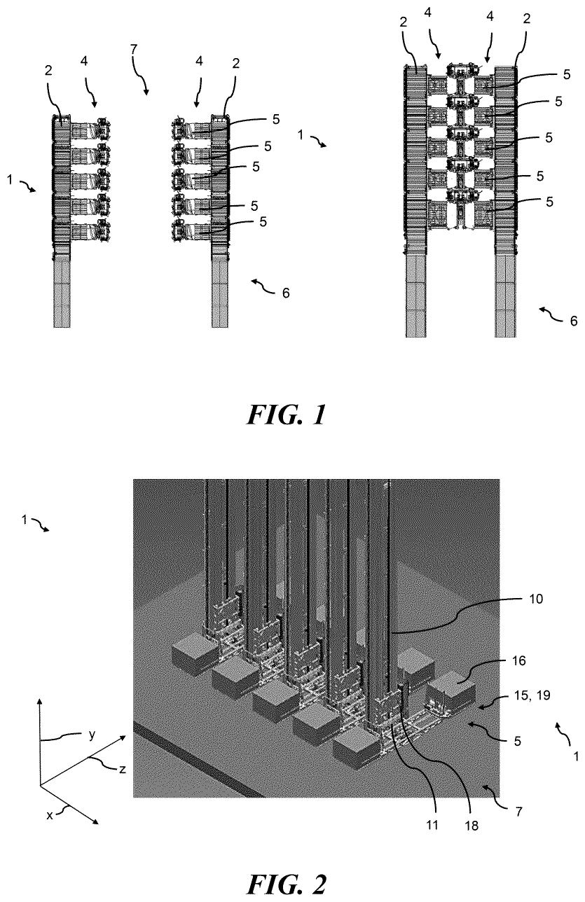

FIG. 1 shows a top view from above of known racking systems 1. The racking system 1 in FIG. 1 on the left comprises a rack storage unit having two storage racks 2. A total of ten rack operating devices 5 are shown in front of or next to the storage racks 2, e.g., in two rows 4, at a distance from the storage rack 2. Further infeeding/outfeeding conveyor systems or rack structures 6 are indicated below in FIG. 1 on the left. FIG. 1 clearly shows that rows 4 of the rack operating devices 5 are at a considerable distance from the storage rack 2 and that rows 4 of the rack operating devices 5 take up comparatively a great deal of space in a rack aisle 7. The racking system 1 in FIG. 1 on the right is explained in more detail in the description of FIG. 2.

FIG. 2 shows an embodiment of the racking system 1 with five rack operating devices 5. Each rack operating device has only one mast 10 which is arranged approximately in the middle of the rack aisle 7. The masts 10 are supported at the ground on concrete foundations 11. Alternatively, the masts could, for example, stand on preferably height-adjustable feet.

Each rack operating device 15 has two load-handling devices 15, which, with their tines—not visible in FIG. 2—make it possible to grip from below many different conveyed and/or stored items 16—shown as cuboids in FIG. 2 as an example. The load-handling device 15, like the lifting cage 18, is part of the lifting unit 19.

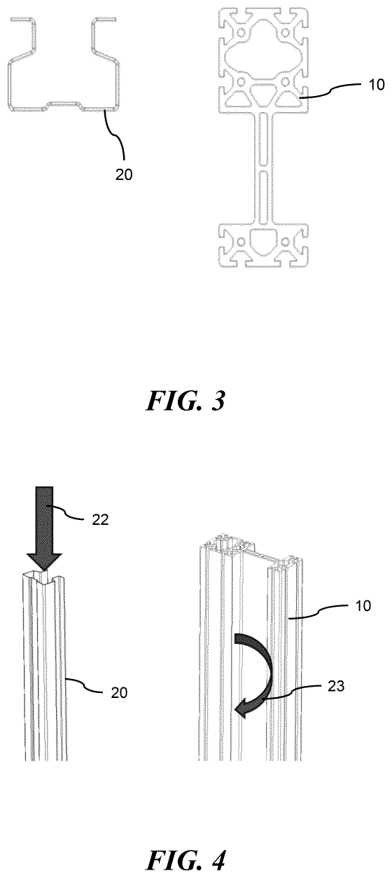

In FIG. 3, a conventional rack upright 20 is shown on the left and a mast 10 on the right in cross-section. The rack upright 10 is made of thin sheet steel. The mast has a larger and braced cross-section so that the mast 20 has a considerably larger geometrical moment of inertia.

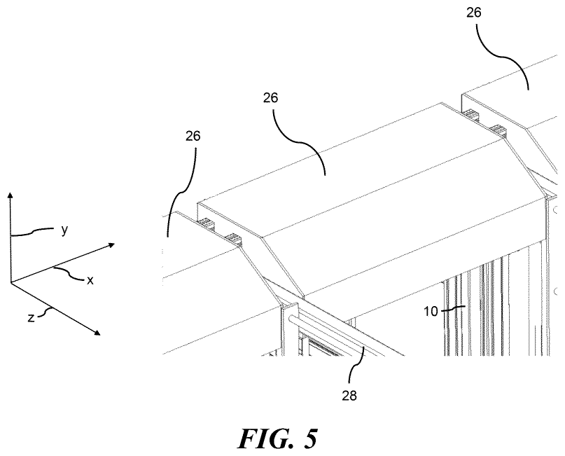

FIG. 4—on the left, the conventional rack upright 20 is again visible, and on the right, the mast 10—shows that the rack upright 20 is optimized for compressive loads 22 from above, while the mast 10 withstands bending stresses and loads due to torques 23 about the vertical y-axis significantly better than the rack upright 20, even when the mast 10 is made of aluminum.

FIG. 5 shows how the mast heads can be connected to crossbeams 26. Cross struts in the form of crossbeams 26 are arranged at the top of the masts 10. The crossbeams 26 connect the mast heads in the horizontal x-direction and brace the racking system. In addition, a bracing element 28 is indicated which runs in the horizontal z-direction and can connect the mast 10 arranged in the rack aisle with the storage rack or with two opposite storage racks of the racking system.

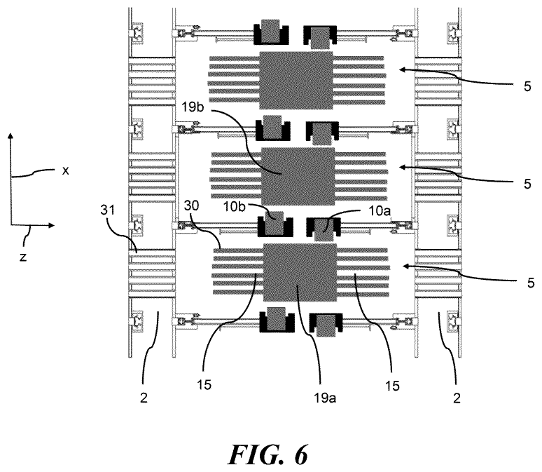

FIG. 6 shows an embodiment of the racking system 1 according to the disclosure. Three rack operating devices 5 are shown. Each lifting unit 19 carries two load-handling devices 15. The load-handling devices 15 have tines 30 that fit into or between the compartment supports 31 of the storage rack 2 and can thereby serve the storage racks. Each lifting unit 19 is assigned two masts 10a, 10b of its own which are each located to the side of the lifting unit 19 in the x-direction, in other words to the left and right from the perspective of an observer standing in front of the respective storage rack 2.

In this case, each lifting unit has its own two mast profiles so that each rack operating device 5 is modular and individually adjustable. In addition, the masts can be easily attached to the storage rack with bracing elements in the horizontal z-direction.

The space requirement is reduced. This is because the right-hand mast 10a of the first lifting unit 19a on the left is offset in the horizontal z-direction in relation to the left-hand mast 10b of the second lifting unit 19b on the right, while both masts 10a, 10b are arranged basically at the same height in the x-direction. Due to the offset arrangement, the space required in the x-direction is reduced when several rack operating devices 5 are arranged next to one another.

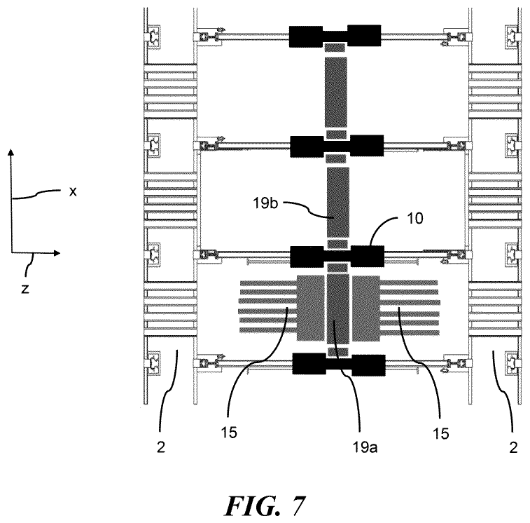

In contrast, FIG. 7 shows another embodiment of the racking system 1 according to the disclosure in which two lifting units 19a, 19b arranged next to each other on the left and right share the mast 10 arranged between them. The mast 10 is thus used by lifting units/lifting cages on both sides. This reduces the overall number of masts 10 and the space required. Assembly time is also saved.

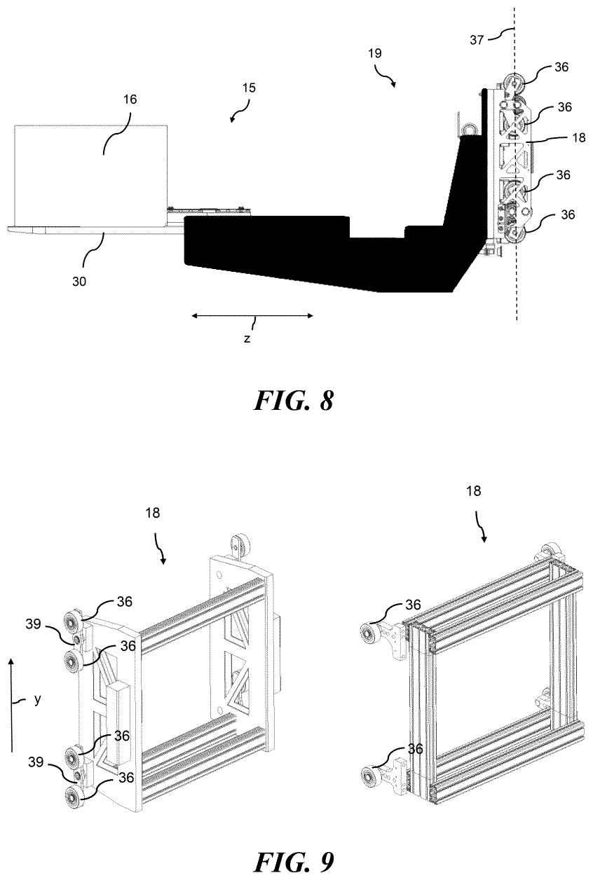

In FIG. 8, a load-handling device 15 can be seen. The load-handling device 15 is in an extended state and carries a stored item 16. In this state, the load-handling device 15 can overcome a large distance in the z-direction so that the stored items 16 can be brought into or removed from a storage rack that is located at a distance from the mast—not shown in FIG. 14—on which the lifting cage 18 can be moved up and down with its rollers 36. The pivot point line 37 in the drawing therefore defines pivot points of the torques that act on the mast via the lifting unit 19.

FIG. 9 shows two embodiments of lifting cages 18 for lifting units of the rack operating device according to the disclosure. Load-handling devices are not shown. The left-hand lifting cage 18 has four rollers 36 on each side, which define a single degree of freedom for the lifting unit on a mast, namely in the vertical direction y. The four rollers 36 are arranged in pairs on two rockers 39 which in the case of large loads are used to compensate for bending loads and/or deformations.

In the right-hand lifting cage 18, not only the horizontal struts—running in the x-direction—are made of aluminum profiles but also the vertical parts running in the y-direction. This makes possible a weight reduction of up to 30%. In addition, the right-hand lifting cage 18 has no rockers and is designed for use with lower loads.

The lifting cages 18 can be provided with sensors for the horizontal axis as well as the vertical axis. In addition, a buffer for the crossing can be provided at the top/bottom of the load-handling device—alternatively or additionally, this is also possible at the mast head or floor.

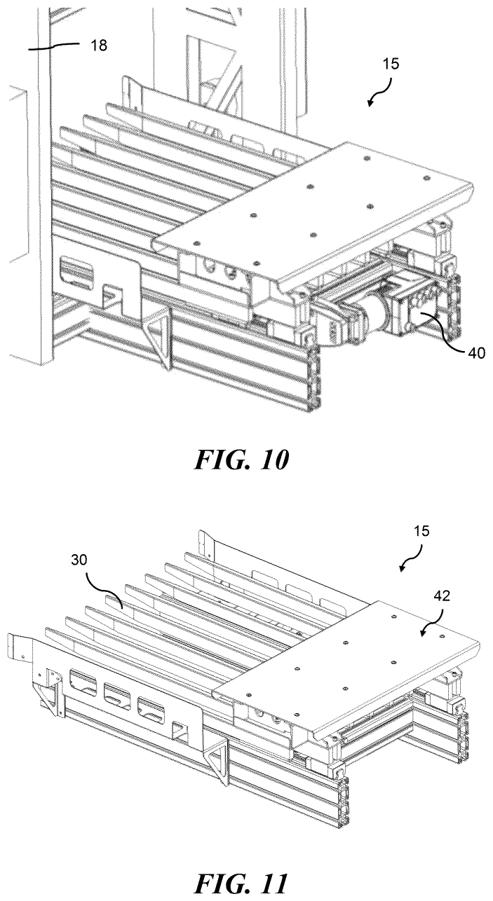

FIG. 10 shows a load-handling device 15 in a retracted state in a lifting cage 18. A removable push-out drive 40 is plugged in at the rear of the load-handling device 15. According to the disclosure, two load-handling devices 15 are provided per lifting cage or per lifting unit.

FIG. 11 shows a modular load-handling device 15 with integrated push-out drive. The tines 30 make it possible for the load-handling device 15 to grip different conveyed and stored items, in particular from below.

The load-handling device 15 has a tine receptacle 42. According to a preferred embodiment, the lifting cage and both load-handling devices 15 are of modular design such that there are various separation points. Cable connections for the sensor system, push-out drives, IO modules and/or energy chains can be designed to be pluggable. This means that the individual assemblies can be easily separated, maintained and/or replaced not only mechanically but also electrically if necessary. In this way, a component or module can be installed quickly, and the repair of defective parts can be carried out outside the operational racking system. This minimizes system downtime. This is particularly important when, for safety reasons, all rack operating devices in at least the relevant row or relevant storage rack must be stopped during access for maintenance purposes. Depending on requirements, smaller assemblies—for example the tine receptacle 42—or larger assemblies—for example the load-handling device 15 including the tine receptacle 42 or the entire lifting unit with both load-handling devices—can be dismantled or replaced all together. Replacing the assembly is considerably less time-consuming than an in-situ repair. The removed assembly can be repaired outside the safety region while the racking system continues to operate.

When replacing the tine receptacle 42, the separation point preferably runs above the carriage of the linear guide of the load-handling device 15. The tine receptacle assembly 42 can be preferably pulled out onto a maintenance trolley (not shown). Electrical separation is not necessary since no electrical components are attached to the tine receptacle 42.

When replacing an entire load-handling device 15 including tine receptacle 42, the separation point is located between the lifting cage and the load-handling device 15. This assembly can also be placed on the maintenance trolley and then mechanically separated from the lifting cage. Alternatively, it is also conceivable to remove the assembly without a maintenance trolley.

When replacing the entire lifting cage including or excluding both load-handling device 15, the separation point can be provided between the suspension means and the lifting cage. The assembly to be replaced can be removed by slackening the suspension means and undoing the attachment of the lifting cage to the suspension means. The rollers of the lifting cage are unscrewed, and the lifting cage can then be removed.

It is possible to remove the lifting cage with or without the load-handling device 15. Removal without the load-handling device 15 requires more steps, but the removed lifting cage alone is lighter and less bulky and therefore easier to handle.

The sensor system and IO modules can be attached to the lifting cage and/or the load-handling device 15.

If the sensor system is located on the load-handling device 15, any mechatronics on the lifting cage can be omitted. Parts such as the push-out drive, the sensor system, IO module and energy chain connection can be assigned to the load-handling device. In case of a defect, the entire load-handling device 15, including all electrical components, can be replaced. This can be a universal troubleshooting solution for all fault cases, which can be performed by operating personnel even without electrical knowledge because there are no electrical connections between the lifting cage and the load-handling device 15. It is possible to replace the load-handling device 15 faster and more easily than replacing the lifting cage. However, there is little space on the load-handling device 15 for attaching the sensor system. In addition, this makes the load-handling device 15 relatively expensive, which is particularly noticeable if additional load-handling devices 15 have to be kept in stock as spare parts.

If the sensor system is located on the lifting cage, the arrangement of the sensor system on the load-handling device 15 can be avoided. As a result, when replacing one of the load-handling device 15, only the cable of the push-out drive or of the load-handling device motor needs to be disconnected, provided that an IO module is not also attached to the load-handling device 15, but at most to the lifting cage. The sensor system of the vertical axis can be positioned particularly easily on the lifting cage. In addition, the load-handling device 15 becomes less expensive, especially as a spare part.

However, if electrical components on the load-handling device 15 are defective, the entire lifting cage must be replaced. This is relatively complex. Alternatively, a specific sensor can be replaced in a targeted manner. However, this involves more complex troubleshooting for appropriately qualified operating personnel. The targeted replacement of individual sensors regularly requires the disconnection of cable connections.

A combination is also conceivable in which, for example, the sensor system for the vertical axis is attached to the lifting cage and the sensor system for the horizontal axis is attached to the load-handling device 15.

Alternatively, the push-out drive or the load-handling device motor may not be located on the load-handling device 15. In this case, the load-handling device 15 can be moved externally by a motor on the lifting cage.

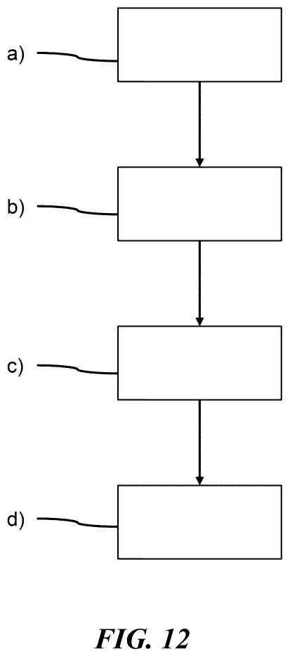

FIG. 12 shows a simplified block diagram of the method according to the disclosure. According to step a), the at least one mast is first assembled with at least one rack storage unit during the construction of the rack storage system. In other words, the rack builder installs the masts of the rack operating devices directly during rack construction. Preferably, the mast head and other parts can also be installed in the process.

In step b), the rack builder can check the dimensional accuracy. According to step c), the lifting unit of the racking system and preferably the drive devices and/or load-handling devices are mounted. The drive unit and the deflection can be mounted—preferably before mounting the lifting unit—unless both form a module.

Finally, in step d), the wiring and preferably the installation of the sensor system follows. The wiring can be simplified if individual elements are wired in advance as far as possible. It would be conceivable, for example, for all elements to be pre-wired and only one energy chain need to be connected.

During wiring, an energy chain can preferably be arranged to the side of the load-handling device.

According to one embodiment, the energy chain can have a fixed point on the storage rack or on a bracing of the mast profiles, in particular at half the mast height. This results in a short energy chain with a short supply line.

Alternatively, a fixed point can be provided at the level of the mast head—either directly on the mast head or on the shelf. The supply lines then no longer have to be routed up each individual mast. Instead, the energy chain supply line can be run upwards centrally at one point on the storage rack and then be distributed to the individual fixed points at the top. An energy chain guide is not required since there is sufficient space. Eliminating the energy chain guide is also advantageous for reasons of space and reduces costs.

Alternatively, a busbar or a leaky waveguide or another method for energy and/or data transmission, for example optical, radio, etc., can be used for the “wiring”.

When placing the sensors, the lifting sensor system—vertical axis—can be stationary, and the sensor system of the load-handling device—horizontal axis—can be designed to travel along. This means that no switching plates are required on the rack operating unit. However, there is little installation space available on the mast for this since attachment options for the sensor system, cable ducts, IO modules, etc., are required.

Alternatively, the entire sensor system can be designed to be entrained. This results in a clear separation between storage rack/mechanics and automation/mechatronics. Mechanical modules such as the masts and mast heads are already mounted with the storage rack. There is a low risk of damage from “rough” assembly by the rack builder since the number of modules is reduced to a minimum. Essentially, only profiles and deflections need to be mounted.

Mechatronic modules such as drive devices, push-out drives, lifting cages and load-handling devices are part of the automation. Compared to a mast, they are small and compact. This means that even in tight spaces, they can be introduced and mounted within a very short time after the rack has been completed. The mechatronic modules are therefore independent of the mast for assembly purposes. The energy chain is also removed or mounted independently of the mast.

The entire sensor system can be designed to be entrained if the sensor system is arranged centrally on the lifting cage and/or the load-handling device, including the sensor system for the vertical axis. In this case, the sensor system, cables and cable routing on the mast are eliminated completely or at least to a large extent. This is particularly important if both wide sides of the mast profile are occupied by lifting cages and therefore only the narrow front side and possibly the back of the mast profile could be used. Electrical components on the mast are only required when a stationary maintenance support is used. The stationary maintenance support can be designed as a bracket that can be extended by motor to automatically secure the lifting unit, in particular the load-handling device. The sensor system is better protected on the load-handling device since damage is avoided during erection of the mast. It is also impossible for the operating personnel to accidentally “kick off” the sensor system at leg height.

All sensors can be captured with a few IO modules or passive distributors on the lifting cage/load-handling device, including the push-out drive if required. This also means that the sensor cables are very short, for example only one meter instead of ten meters, and independent of the mast height. The cables from the IO module can be transmitted to a programmable logic controller via an energy chain or the alternative data transmission paths mentioned above.

Defective electrical components can be easily replaced by moving the load-handling devices to working height. This means that the operating personnel do not have to climb up the storage rack to replace a sensor. In addition, if a cable is defective, only very short cables need to be replaced, which means that the length of the cable routing is reduced. However, switching plates on the mast/storage rack are required. With stationary maintenance supports, electrical components are still required on the mast.

After the assembly process is completed, commissioning can begin.

With regard to further advantageous embodiments of the device according to the disclosure, reference is made to the general part of the description and to the appended claims in order to avoid repetitions.

Finally, it is expressly pointed out that the exemplary embodiments described above of the device according to the disclosure serve only to explain the claimed teaching, but do not limit it to the exemplary embodiments.

### LIST OF REFERENCE SIGNS

1 Racking system
2 Storage rack
4 Rows
5 Rack operating device
6 Rack structures
7 Rack aisle
10, 10a, 10b Mast
11 Concrete foundation
15 Load-handling device
16 Stored items
18 Lifting cage
19, 19a, 19b Lifting unit
20 Conventional rack upright
22 Pressure load
23 Torque around the vertical y-axis
25 Drive device
26 Crossbeam at the mast head
28 Bracing
30 Tines
31 Compartment support
36 Roller
37 Pivot point line
39 Rocker
40 Push-out drive
42 Tine receptacle
a), b), c), d) Steps
x, y, z Directions in the coordinate system

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A rack operating device for a rack system for storage and retrieval, wherein the rack operating device has at two masts extending in a vertical direction and a lifting unit movably arranged on the masts,
wherein the lifting unit carries two load-handling devices that are moveable in a horizontal direction in the lifting unit.

2. The rack operating device according to claim 1, wherein the two masts are arranged offset from one another in the horizontal z-direction, while both masts are arranged essentially identically in the x-direction.

3. The rack operating device according to claim 1, wherein two lifting units arranged next to each other on the left and right share the mast arranged between them.

4. The rack operating device according to claim 1, wherein the lifting unit is fixed to the mast with one degree of freedom in the vertical direction.

5. The rack operating device according to claim 1, wherein the two load-handling devices are aligned in opposite orientations in the horizontal direction.

6. A racking system for storage and retrieval, comprising:
a rack storage unit with at least two opposing storage racks, wherein the at least two storage racks have one or more compartments for stored items in one rack level or in a plurality of rack levels arranged one above the other; and
at least one rack operating device according to claim 1.

7. The racking system according to claim 6, wherein at least two masts are connected by at least one cross strut extending in a horizontal direction.

8. The racking system according to claim 6, wherein the mast heads of two masts arranged next to one another are connected to one another by a crossbeam.

9. The racking system according to claim 6, wherein a rack aisle is formed between two storage racks, and wherein a mast arranged in the rack aisle is connected to the two storage racks by way of at least one bracing element.

10. A method for assembling a racking system according to claim 6, comprising:
a) mounting of at least one mast when constructing the rack storage unit with at least one storage rack;
b) checking dimensional accuracy and/or maintenance of tolerances;
c) mounting the lifting unit(s) of the racking system; and
d) wiring and installing the sensor system.

11. The method according to claim 10, further comprising mounting the load-handling devices that are moveable in a horizontal direction in the lifting unit.
